(19) United States
(12) Patent Application Publication
(10) Pub. No.: US 2011/0222011 A1
(43) Pub. Date: Sep. 15, 2011

(54) LIQUID CRYSTAL DISPLAY DEVICE AND ELECTRONIC DEVICE

(76) Inventors: Atsuhito Murai, Osaka (JP); Hajime Imai, Osaka (JP); Hideki Kitagawa, Osaka (JP)

(21) Appl. No.: 13/130,253

(22) PCT Filed: Jul. 30, 2009
(86) PCT No.: PCT/JP2009/063606

§ 371 Date: May 19, 2011

(30) Foreign Application Priority Data
Nov. 21, 2008 (JP) 2008-298689

(51) Int. Cl. G02F 1/1343

(52) U.S. Cl. 349/140

(57) ABSTRACT

A liquid crystal display device of the present invention includes: a TFT array substrate (200); a counter substrate (100); a liquid crystal layer (300) formed between the TFT array substrate (200) and the counter substrate (100); a photodiode (17) formed on the TFT array substrate (200), which photodiode (17) generates an electric current equivalent to intensity of irradiation light irradiated to the photodiode (17); and a light transmitting member (15) employing a non-hollow solid structure, which light transmitting member (15) is provided on a light-receiving surface of the photodiode (17) and sandwiched between the TFT array substrate (200) and the counter substrate (100). This makes it possible to attain, by a simple arrangement, a liquid crystal display device including an optical sensor (photoelectric element) which is not affected by an alignment state of liquid crystal and which has an excellent detection sensitivity.

### TECHNICAL FIELD

The present invention relates to a liquid crystal display device into which an optical sensor is incorporated.

### BACKGROUND ART

Conventionally, there has been proposed a display device including a display panel in which an optical sensor included in a pixel is incorporated.

A photodiode (photoelectric element) is generally used as the optical sensor included in the display device. Sensitivity of the photodiode is generally indicated by S (signal)/N (noise). That is, increasing in a value of S/N causes an excellent sensitivity.

For example, Patent Literature 1 discloses a method for improving the sensitivity of the optical sensor incorporated in the pixel included in the display panel. The method is specifically a method for decreasing noise caused by light that enters the optical sensor, so that S/N is improved. That is, a technique disclosed in Patent Literature 1 improves the sensitivity by decreasing photoelectric current indicated by N (noise) of S/N that indicates the sensitivity of the photodiode.

Specifically, as shown in FIG. 19, a liquid crystal display device disclosed in Patent Literature 1 is arranged such that a groove is formed so as to surround a sensor part and a light shielding member or a light absorbent member is embedded in the groove. This arrangement makes it possible to prevent noise caused by light (stray light) which repeats complex reflection mainly in a substrate and enters the sensor part.

Further, as with Patent Literature 1, Patent Literature 2 discloses an arrangement in which an imaging element (optical sensor) is surrounded by a light shielding insulating layer. This arrangement makes it possible to decrease entering of light (stray light) other than light that originally enters the imaging element.

Further, Patent Literature 3 discloses a technique in which a light condensing member (lens) is provided in a front of a photoelectric transducer so that light enters the photoelectric transducer via the light condensing member for condensing, on the photoelectric transducer, the light that enters the photoelectric transducer, so that sensitivity of the photoelectric transducer (optical sensor) increases.

### CITATION LIST

### Patent Literature

Patent Literature 1
Japanese Patent Application Publication Tokukaihei No. 11-95263 A (Publication Date: Apr. 9, 1994)

Patent Literature 2
Japanese Patent Application Publication Tokukai No. 2006-65305 A (Publication Date: Mar. 9, 2006)

Patent Literature 3
Japanese Patent Application Publication Tokukai No. 2005-10228 A (Publication Date: Jan. 13, 2005)

### SUMMARY OF INVENTION

### Technical Problem

However, Patent Literatures 1 and 2 have a problem that it is extremely complicate (increasing in manufacturing processes and cost) to form a light shielding member. That is, in a case where a high-definition display device is manufactured, it is necessary to conduct an extremely complicate process for providing the light shielding member to each of the optical sensor parts included in the display device.

Further, the light shielding material is just formed so as to surround the optical sensor part. This provides, between the light shielding member and the optical sensor part, an empty space including neither a liquid crystal material nor anything. This possibly causes a trouble at the time of manufacturing the display device. The problem is, for example, entering the liquid crystal material into the space. Such entering the liquid crystal material into the space leads to the presence of liquid crystal on the optical sensor part. As a result of this, light affected by an alignment state of the liquid crystal enters the optical sensor, thereby decreasing sensitivity of the optical sensor.

Further, according to Patent Literature 3, the light shielding member is not provided around a photoelectric transducer. This unfortunately causes light transmitted through an adjacent light condensing member or light that obliquely enters between one light condensing member and another light condensing member to enter the photoelectric transducer as stray light even in a case where the light condensing members condense light that enters the photoelectric transducer. As a result, light detection sensitivity possibly decreases in the photoelectric transducer serving as the optical sensor.

The present invention was made in view of the above problems, and an object of the present invention is to attain a liquid crystal display device provided with an optical sensor (photoelectric element) which is not affected by the alignment state of the liquid crystal, which is hard to be subject to noise caused by stray light, and which has an excellent detection sensitivity.

### Solution to Problem

In order to attain the object, a liquid crystal display device of the present invention, including: a TFT array substrate; a counter substrate; liquid crystal provided between the TFT array substrate and the counter substrate; a photoelectric element formed on the TFT array substrate, which photoelectric element generates an electric current equivalent to intensity of irradiation light irradiated to the photoelectric element; and a light transmitting member employing a non-hollow solid structure, which light transmitting member is provided on a light-receiving surface of the photoelectric element and sandwiched between the TFT array substrate and the counter substrate.

According to the above arrangement, the light transmitting member employing the non-hollow solid structure is provided on the light-receiving surface of the photoelectric element and sandwiched between the TFT array substrate and the counter substrate. Light transmitted through the light transmitting member enters the light-receiving surface of the photoelectric element.

Further, the light transmitting member is sandwiched between the TFT array substrate and the counter substrate. Therefore, a liquid crystal layer is provided neither between the light transmitting member and the counter substrate nor between the light transmitting member and the TFT array substrate. Furthermore, the light transmitting member employs the non-hollow solid structure. Therefore, a liquid crystal material of the liquid crystal layer does not soak into the light transmitting member. This allows light to enter the light-receiving surface of the photoelectric element on which surface no liquid crystal is provided.

That is, light which is not affected by an alignment state of the liquid crystal enters the photoelectric element. This makes it possible to generate electric current equivalent to intensity of light that enters the photoelectric element.

Further, the light transmitting member employing the non-hollow solid structure can be simply structured by means of a conventional technique. It is therefore possible to manufacture the light transmitting member by a simple process.

In this manner, a liquid crystal display device including a photoelectric element which is not affected by the alignment state of the liquid crystal, which is hard to be subject to noise due to stray light, and which has an excellent detection sensitivity can be attained by a simple arrangement.

It is preferable that the light transmitting member is provided above the photoelectric element and in a region that is under influence of light, so that the electric current generated by the photoelectric element depends on the influence of the light in the region.

This allows light which is not affected at all by the alignment state of the liquid crystal to enter the region that affects sensor sensitivity of the photoelectric element. It is therefore possible to further improve the detection sensitivity of the photoelectric element.

It is preferable that the light transmitting member is provided so as to cover at least a semiconductor layer region constituting the photoelectric element.

According to the above arrangement, the semiconductor layer region serving as the light-receiving surface of the photoelectric element is covered with the light transmitting member. This allows merely light that enters from the light transmitting member which is not affected at all by the alignment state of the liquid crystal to enter the photoelectric element. It is accordingly possible to further improve the detection sensitivity of the photoelectric element.

Examples of the arrangement of the photoelectric element encompass the following three arrangements.

The photoelectric element employs a TFT structure in which the photoelectric element includes at least a gate electrode, a gate insulating film, a semiconductor layer, a source electrode, a drain electrode, and a contact layer via which the source electrode is electrically connected to the drain electrode, the light transmitting member is provided at least in a region where the gate electrode overlaps with the semiconductor layer and neither the source electrode nor the drain electrode is provided.

The light transmitting element employs a lateral structure in which (i) the light transmitting element includes at least a p-type semiconductor layer, an i-type semiconductor layer, an n-type semiconductor layer, electrodes connected to the p-type semiconductor layer and the n-type semiconductor layer, respectively, and (ii) interfaces of the p-type, the i-type and the n-type semiconductor layers are perpendicular to a surface of the TFT array substrate, the light transmitting member is provided at least above the semiconductor layer and in a region where the electrodes are not provided.

The light transmitting element employs a vertical structure in which (a) the light transmitting element includes at least a p-type semiconductor layer, an i-type semiconductor layer, an n-type semiconductor layer, electrodes connected to the p-type semiconductor layer and the n-type semiconductor layer, respectively, and (b) interfaces of the p-type, the i-type and the n-type semiconductor layers are provided along a surface of the TFT array substrate, the light transmitting member is provided above one of the p-type, the i-type and the n-type semiconductor layers which one is provided closest to a side which light enters.

The light transmitting member also serves as a spacer that determines a gap between the TFT array substrate and the counter substrate.

According to the above arrangement, a process for forming the light transmitting member is substituted for a process for forming a spacer. It is therefore possible to manufacture the liquid crystal display device in which the light transmitting member is formed on the photoelectric element, without changing the number of processes for manufacturing the liquid crystal display device.

The liquid crystal display device of the present invention includes a color filter between the light transmitting member and the counter substrate.

According to the above arrangement, light that enters from the counter substrate is transmitted through the color filter, and enters the light transmitting member. It is therefore possible to simply determine a transmission wavelength of light that enters the photoelectric element merely by adjusting a wavelength transmitted through the color filter.

It is preferable that the light transmitting member is made from a resin material having at least photosensitivity.

According to the above arrangement, it is possible to simply form the light transmitting member by patterning employing photolithographic method.

Further, it is possible to determine a wavelength transmitted through the light transmitting member, by simple methods such as a method for causing the photosensitive resin material to have a property of transmitting/absorbing light having a specific wavelength, a method for causing the photosensitive resin material to have a patterning property obtained by means of photolithographic method and mixing, with the photosensitive resin material, a material that transmits/absorbs the light having the specific wavelength (specifically, mixing a color filter pigment or the like with the photosensitive resin material). This expands the scope of materials to be selected.

It is preferable that the light transmitting member is made from a material whose refraction index is greater than that of the liquid crystal.

According to the above arrangement, difference in refraction index between the light transmitting member and the liquid crystal makes it possible to reflect, on the light transmitting member, a part of stray light that enters from the liquid crystal. This reduces the stray light to enter the photoelectric element.

It is preferable that the light transmitting member is made from a light absorbent material that absorbs light having a specific wavelength.

According to the above arrangement, light that enters the light transmitting member which light is other than light absorbed into a light absorbent material included in the light transmitting member is guided to the photoelectric element. Further, as described above, the light transmitting member provided on the photoelectric element is made from the light absorbent material that absorbs light that enters the photoelectric element as stray light. This makes it possible to reduce the stray light to enter the photoelectric element.

The above-arranged liquid crystal display device is applicable to various electronics devices. Particularly, the above-arranged liquid crystal display device is suitably applicable to an electronics device including a touch panel and/or a scanner.

### Advantageous Effects of Invention

As described above, a liquid crystal display device of the present invention includes: a TFT array substrate; a counter substrate; liquid crystal provided between the TFT array substrate and the counter substrate; a photoelectric element formed on the TFT array substrate, which photoelectric element generates an electric current equivalent to intensity of irradiation light irradiated to the photoelectric element; and a light transmitting member employing a non-hollow solid structure, which light transmitting member is provided on a light-receiving surface of the photoelectric element and sandwiched between the TFT array substrate and the counter substrate. Accordingly, a liquid crystal display device including a photoelectric element which is not affected by an alignment state of the liquid crystal, which is hard to be subject to noise due to stray light, and which has an excellent detection sensitivity can be attained by a simple arrangement.

### BRIEF DESCRIPTION OF DRAWINGS

In FIG. 1, (a) and (b) are cross-sectional views each schematically showing a principal part of a liquid crystal display device in accordance with an embodiment of the present invention.

FIG. 2 is a block diagram showing a principal arrangement of the liquid crystal display device shown in FIG. 1.

FIG. 3 is an equivalent circuit diagram of one pixel included in the liquid crystal display device shown in FIG. 2.

FIG. 4 is a plan view of one pixel included in the liquid crystal display device shown in FIG. 2.

FIG. 5 is a cross-sectional view of one pixel taken along A-A′ line shown in FIG. 4.

FIG. 6 is a cross-sectional view of one pixel taken along B-B′ line shown in FIG. 4.

FIG. 7 is a cross-sectional view of one pixel taken along C-C′ line shown in FIG. 4.

FIG. 8 is a view showing processes for forming an active matrix substrate, the processes being included in a method for manufacturing the liquid crystal display device shown in FIG. 2.

FIG. 9 is a view showing processes for forming a common substrate, the processes being included in the method for manufacturing the liquid crystal display device shown in FIG. 2.

FIG. 10 is a cross-sectional view schematically showing the vicinity of a transparent member included in a liquid crystal display device in accordance with another embodiment of the present invention.

FIG. 11 is a cross-sectional view schematically showing the vicinity of a transparent member included in a liquid crystal display device in accordance with yet another embodiment of the present invention.

FIG. 12 is a cross-sectional view schematically showing the vicinity of a transparent member included in a liquid crystal display device in accordance with still yet another embodiment of the present invention.

In FIG. 13, (a) and (b) are views showing a position where a light transmitting member is provided in a case where a photoelectric element employs a TFT structure.

In FIG. 14, (a) and (b) are views showing a position where a light transmitting member is provided in a case where a photoelectric element is a pin photodiode employing a lateral structure.

In FIG. 15, (a) and (b) are views showing a position where a light transmitting member is provided in a case where a photoelectric element is a pin photodiode employing a vertical structure.

In FIG. 16, (a) and (b) are views showing comparative examples for describing an effect of the present invention.

In FIG. 17, (a) and (b) are views showing an effect of the present invention.

In FIG. 18, (a) and (b) are views showing an effect of the present invention.

FIG. 19 is a block diagram showing a principal arrangement of a conventional liquid crystal display device.

### DESCRIPTION OF EMBODIMENTS

The following describes an embodiment of the present invention. The present embodiment describes a case where a display device of the present invention is applied to a liquid crystal display device into which an optical sensor touch panel is incorporated (hereinafter referred to as an optical sensor TP system).

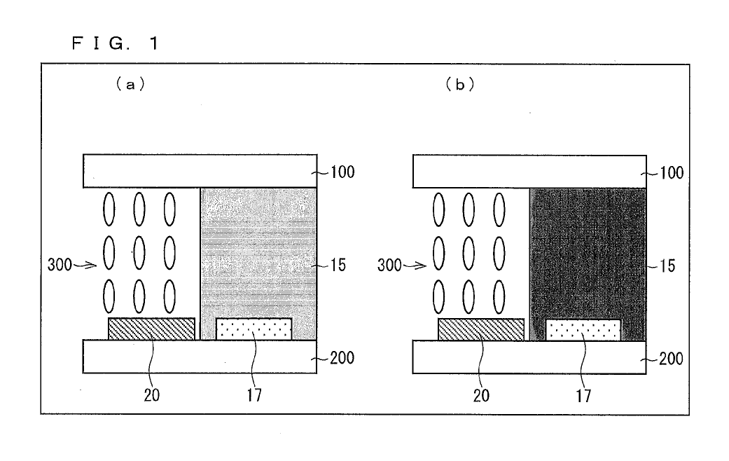

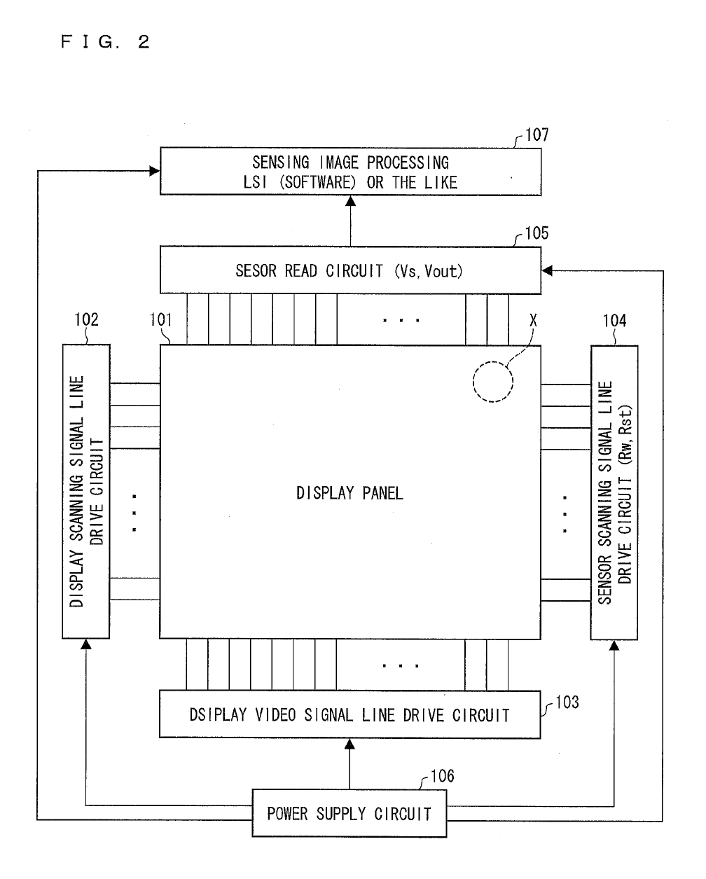

As shown in FIG. 2, the optical sensor TP system of the present embodiment is provides with: a display panel 101 including a photoelectric element serving as an optical sensor, the display panel 101 being provided in the center of the optical sensor TP system; a display scanning signal line drive circuit 102 and a display video signal line drive circuit 103 that are circuits for causing the display panel 101 to display; a sensor scanning signal line drive circuit 104 and a sensor read circuit 105 that are circuits for causing the display panel 101 to serve as a touch panel; a sensing image processing LSI 107 (PC (including software)) for determining a touched coordinate from sensing data transmitted from the sensor read circuit 105; and a power supply circuit 106.

The liquid crystal display device shown in FIG. 2 is an example of the present embodiment. The liquid crystal display device of the present embodiment is not limited to this arrangement. Functions of the sensor scanning signal line drive circuit 104 and the sensor read circuit 105 may be included in other circuits, for example, the display scanning signal line drive circuit 102 and the display video signal line drive circuit 103. Further, the function of the sensor read circuit 105 may be included in the sensing image processing LSI 107.

As shown in (a) and (b) of FIG. 1, the display panel 101 is arranged such that a liquid crystal layer 300 is sandwiched between a counter substrate 100 and a TFT array substrate 200. Specifically, (a) and (b) of FIG. 1 each schematically show a cross section of one pixel.

A display drive TFT (Thin Film Transistor) element 20 for driving a pixel electrode (not shown), and a photodiode serving as a photoelectric element in which electric current equivalent to intensity of irradiation light is generated are formed on the TFT array substrate 200. A light transmitting member 15 employing a non-hollow solid structure is formed on a light receiving surface of the photodiode 17 and sandwiched between the TFT array substrate 200 and the counter substrate 100.

By providing the light transmitting member 15 on the photodiode 17 as described above, no liquid crystal is provided on the photodiode 17. This allows the photodiode 17 to constantly receive light that is not affected by an alignment state of liquid crystal.

Further, the light transmitting member 15 is sandwiched between the TFT array substrate 200 and the counter substrate 100. This makes it possible to adjust a gap of a thickness of a cell. It is accordingly possible to substitute the light transmitting member 15 for a spacer. Providing the light transmitting member 15 prevents increase in cost.

Further, it is considered that the light transmitting member 15 is made from, for example, a resin material having at least photosensitivity. In order to form the light transmitting member 15, a photosensitive resin material and a material to be combined with the resin material may be selected as appropriate so as to be in accordance with sensitivity of the photodiode 17, light wavelength to be transmitted or the like. This expands the scope of selected materials for forming the light transmitting member 15. The function of the light transmitting member 15 may be attained just by using the resin material. Alternatively, the light transmitting member 15 may be formed by mixing the resin material with, for example, a light absorbent material, so that the light transmitting member 15 attains the desired function.

In a case where the light transmitting member 15 is formed under the above condition, an uncolored light transmitting member 15 can be formed as shown in (a) of FIG. 1, and a colored light transmitting member 15 can also be formed as shown in (b) of FIG. 1.

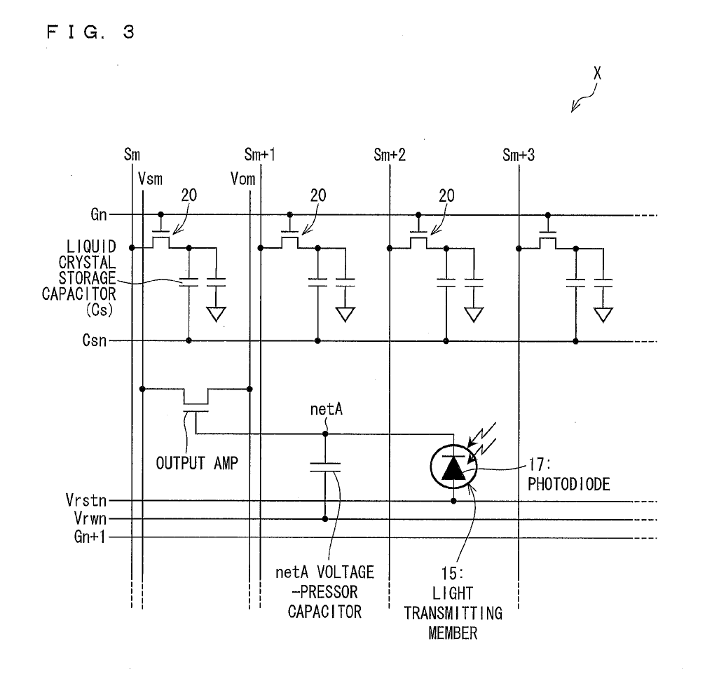

FIG. 3 is a view showing an equivalent circuit of one pixel which view is obtained by enlarging a part of the display panel 101 shown in FIG. 2. The display panel 101 is supposed to be an active matrix liquid crystal display panel in which pixels are arranged in a matrix manner and each of the pixels drives independently. In FIG. 3, reference signs n, n+1, m, and m+1 described in edges of wirings indicate n line, n+1 line, m line, and m+1 line, respectively.

As shown in FIG. 3, a pixel X included in the display panel 101 is provided with a gate wiring Gn, a source wiring Sm and a storage light condensing member wiring Csn that are display wirings, and a photodiode reset wiring Vrstn, a NetA voltage raising light condensing member wiring Vrwn, a voltage supply wiring Vsm for supplying a voltage to an output AMP and an optical sensor output wiring Vom that are detection circuit wirings.

The gate wiring Gn is a wiring for supplying, to the display drive TFT element 20, a scanning signal transmitted from the display scanning signal line drive circuit 102. The source wiring Sm is a wiring for supplying, to the display drive TFT element 20, a video signal transmitted from the display video signal line drive circuit 103 which wiring is provided orthogonally to the gate wiring Gn.

The storage light condensing member wiring Csn is positioned parallel to the gate wiring Gn, and connected to a storage light condensing member Cs formed in the display drive TFT element 20.

The photodiode reset wiring Vrstn is positioned parallel to the gate wiring Gn, and connected to an anode side of the photodiode 17. The photodiode reset wiring Vrstn is a wiring for supplying a reset signal transmitted from the sensor scanning signal line drive circuit 104.

The NetA voltage raising light condensing member wiring Vrwn is positioned parallel to the gate wiring Gn, and connected to an electrode of a NetA voltage raising light condensing member connected in parallel with a node of a cathode side of the photodiode 17, that is, a NetA, the electrode being opposite to the node, that is, the NetA.

The voltage supply wiring Vsm for supplying a voltage to the output AMP is positioned parallel to the source wiring Sm, and connected to a source electrode of the output AMP.

The optical sensor output wiring Vom is a wiring for outputting, to the sensor read circuit 105, an output signal outputted from the output AMP which output signal changes in accordance with quantity of light that the photodiode 17 receives.

The optical sensor output wiring Vom is positioned parallel to the source wiring Sm, and connected to a drain electrode of the output AMP.

As shown in FIG. 3, the light transmitting member 15 is positioned on the photodiode 17.

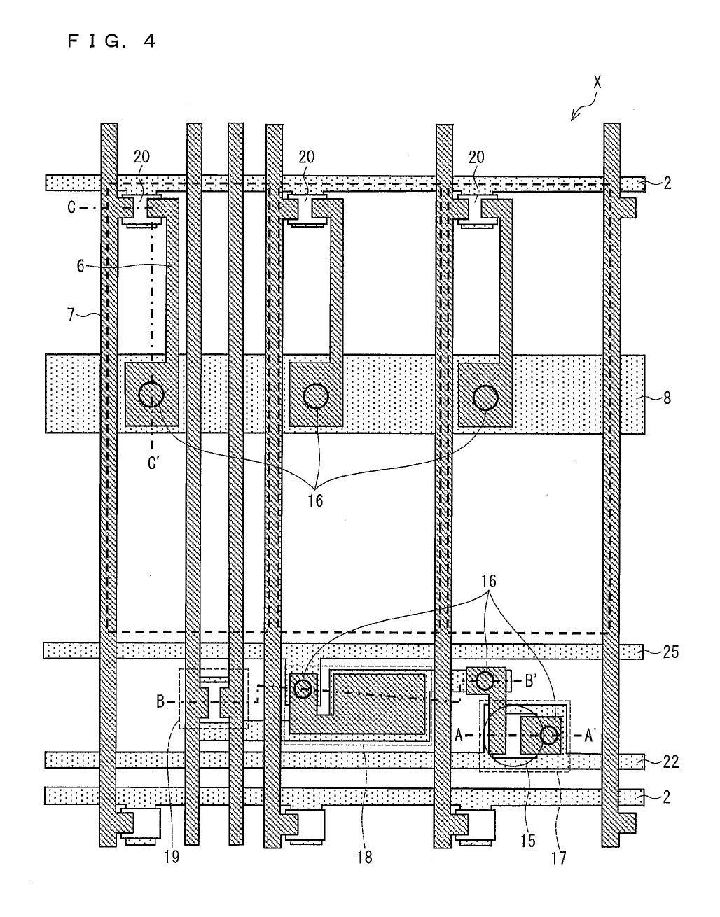

FIG. 4 is a plan view specifically showing a wiring arrangement of the equivalent circuit of the one pixel shown in FIG. 3.

Specifically, FIG. 4 shows an arrangement of a wiring and element of a side in which the TFT array substrate 200 is provided. An arrangement of a wiring and element of a side in which the counter substrate is provided is omitted in FIG. 4.

FIGS. 5, 6 and 7 are cross-sectional views schematically showing three parts of the plan view shown in FIG. 4, respectively.

Specifically, FIG. 5 is a cross-sectional view of the one pixel taken along A-A′ line shown in FIG. 4.

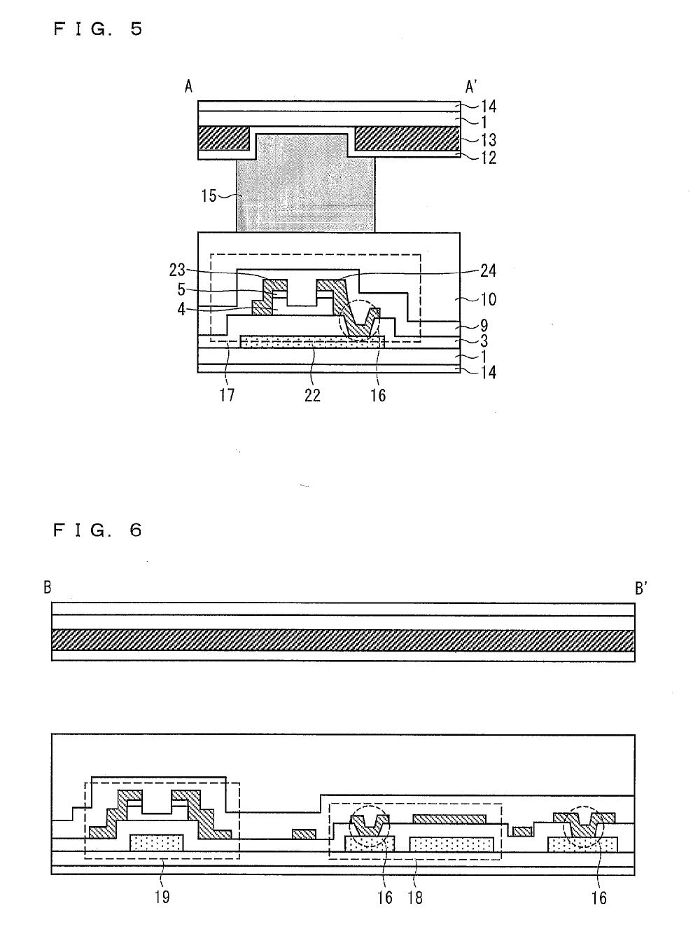

Further, FIG. 6 is a cross-sectional view of the one pixel taken along B-B′ line shown in FIG. 4.

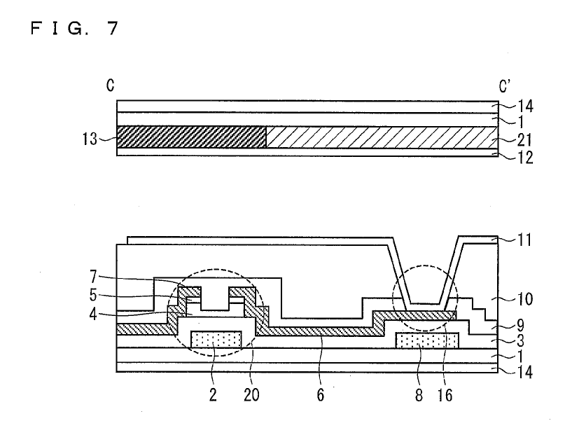

Furthermore, FIG. 7 is a cross-sectional view of the one pixel taken along C-C′ line shown in FIG. 4.

Reference signs shown in FIGS. 4 to 7 indicate as follows.

Reference sign 1 indicates an insulating substrate, reference sign 2 indicates a gate electrode and a gate wiring, reference sign 3 indicates a gate insulating film, reference sign 4 indicates a semiconductor layer (a-Si), reference sign 5 indicates a contact layer (n+ a-Si), reference sign 6 indicates a drain electrode and wiring, reference sign 7 indicates a source electrode and wiring, reference sign 8 indicates a storage light condensing member wiring, reference sign 9 indicates a passivation film, reference sign 10 indicates an interlayer insulating film, reference sign 11 indicates a picture element electrode, reference sign 12 indicates a common electrode, reference sign 13 indicates a light shielding film, reference sign 14 indicates a polarizer, reference sign 15 indicates a light transmitting member, reference sign 16 indicates a contact hole, reference sign 17 indicates a photodiode, reference sign 18 indicates a NetA voltage raising light condensing member, reference sign 19 indicates an output AMP, reference sign 20 indicates a picture element drive TFT, reference sign 21 indicates a color filter, reference sign 22 indicates a gate electrode and wiring (Vrst wiring) of a photodiode, reference sign 23 indicates a drain electrode and wiring of the photodiode, reference sign 24 indicates a source electrode and wiring of the photodiode, and reference sign 25 indicates a Vrw wiring.

An arrangement of the liquid crystal display device in which the above-described electrodes, wirings and elements are provided is general except for an arrangement of the liquid crystal display device in which the light transmitting member 15 is formed. Therefore, description for the arrangement of the liquid crystal display device in which the above-described electrodes, wirings and elements are provided is omitted here.

As shown in FIG. 5, the light transmitting member 15 is a columnar member provided so as to extend from the photodiode 17 formed on the insulating substrate 1 provided closer to the TFT array substrate 200 to the common electrode 12 provided on the insulating substrate 1 provided closer to the counter substrate 100 facing the TFT array substrate 200. Further, the light transmitting member 15 is made from a photosensitive resin material, and employs the non-hollow solid structure. A position where the light transmitting member 15 is provided is described in detail later.

The following describes a method for manufacturing the display panel 101 with reference to the cross-sectional view shown in FIG. 5.

A method for forming a photodiode is described as a representative example with reference to the cross section taken along A-A′ line shown in FIG. 4. Describing the method with reference to the cross section taken along B-B′ line and the cross section taken along C-C′ line is omitted here. First, a process for manufacturing the TFT array substrate 200 is described. Subsequently, a process for manufacturing the counter substrate is described.

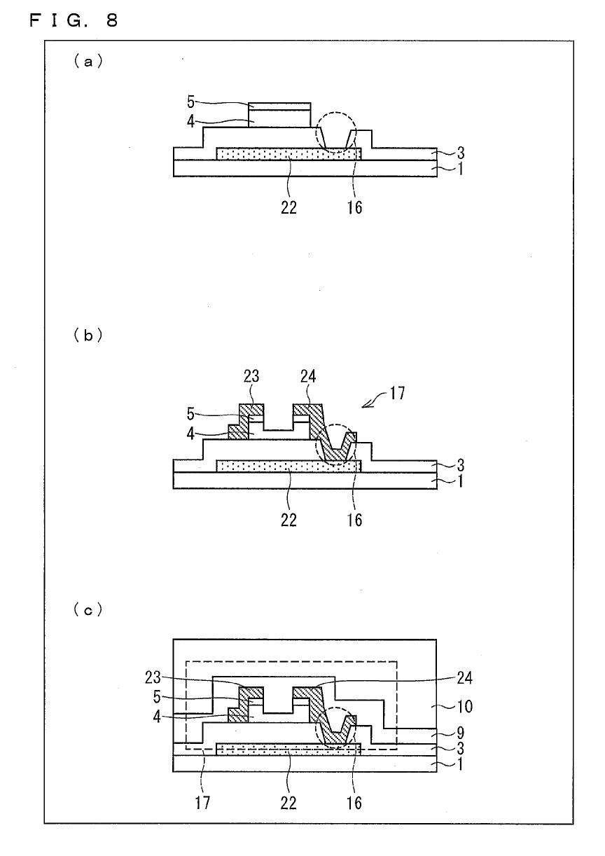

FIG. 8 is a view showing the process for manufacturing the TFT array substrate 200 of the display panel 101.

As shown in (a) of FIG. 8, a metal layer such as Ti/Al/Ti having a thickness of substantially 250 nm is formed on the insulating substrate 1 by sputtering technique, and the gate electrode/wiring (Vrst wiring) 22 of a photodiode serving as a photoelectric element is formed by photolithographic method.

Subsequently, the gate insulating layer (silicon nitride: SiNx) 3 having a thickness of substantially 350 nm, the a-Si layer 4 having a thickness of substantially 150 nm, and the n+ a-Si layer 5 having a thickness of substantially 50 nm are successively formed in this order by plasma CVD method, and then patterned in an island shape by photolithographic method.

Thereafter, the gate insulating film 3 is etched by photolithographic method so as to become a predetermined pattern, so that the contact hole 16, and a terminal pad portion (not shown) for drawing the gate wiring and the source wiring are formed.

Subsequently, as shown in (b) of FIG. 8, a metal layer such as Ti/Al/Ti having a thickness of substantially 250 nm is successively formed by sputtering technique, and the source electrode/wiring 24 of the photodiode and the drain electrode/wiring 23 of the photodiode are formed by photolithographic method. The gate electrode/wiring (Vrst wiring) 22 of the photodiode is electrically connected to the source electrode/wiring 24 of the photodiode via the contact hole 16 formed by a process of (a) of FIG. 8.

Thereafter, channel parts of the a-Si layer 6 and the n+ a-Si layer 7 are formed by dry etching technique employing gas including SF6.

In this manner, the photodiode 17 is formed.

Subsequently, as shown in (c) of FIG. 8, a silicon nitride film serving as the passivation film 9 having a thickness of substantially 350 nm is formed by plasma CVD method, and a low-permittivity photosensitive resin having a thickness ranging from substantially 2500 nm to 4500 nm is then formed by spin method. Thereafter, the contact hole 16 (not shown) for electrically connecting the picture element electrode 11 to the drain electrode/wiring 6, and the terminal pad portion (not shown) for drawing the gate wiring and the source wiring are formed on the photosensitive resin by photolithographic method so that the photosensitive resin serves as the interlayer insulating film 10.

Subsequently, the passivation film 9 is etched by use of the interlayer insulating film 10 serving as a mask by dry etching technique employing gas including CF4/O2.

Thereafter, a transparent electrically-conductive layer made from ITO (indium thin Oxide) which layer has a thickness of substantially 100 nm is formed on the interlayer insulating film 10 by sputtering technique, and the picture element electrode 11 is etched by photolithographic method so as to become a predetermined pattern (not shown).

In this manner, the TFT array substrate 200 of the present invention is manufactured.

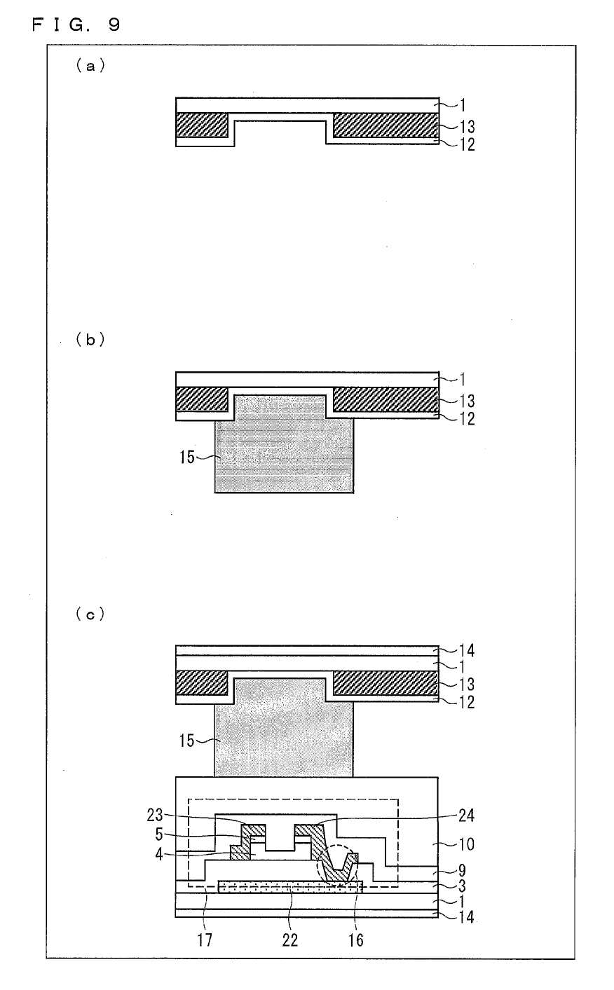

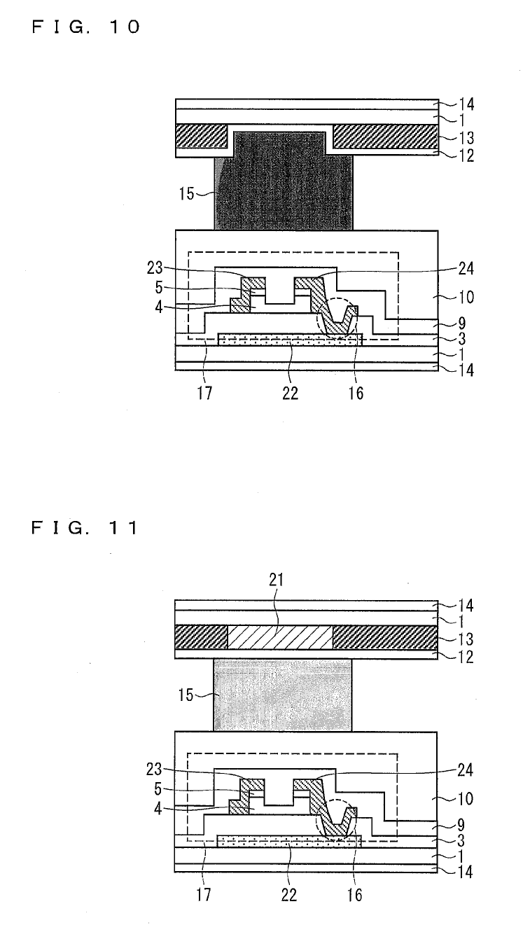

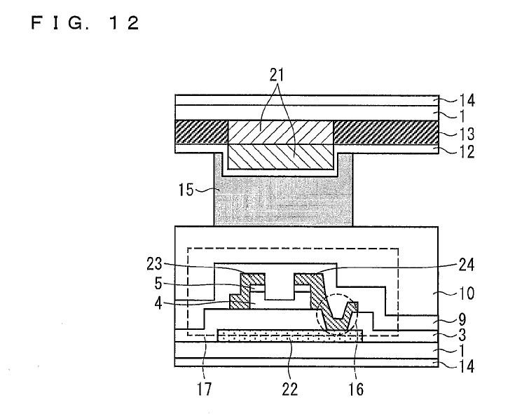

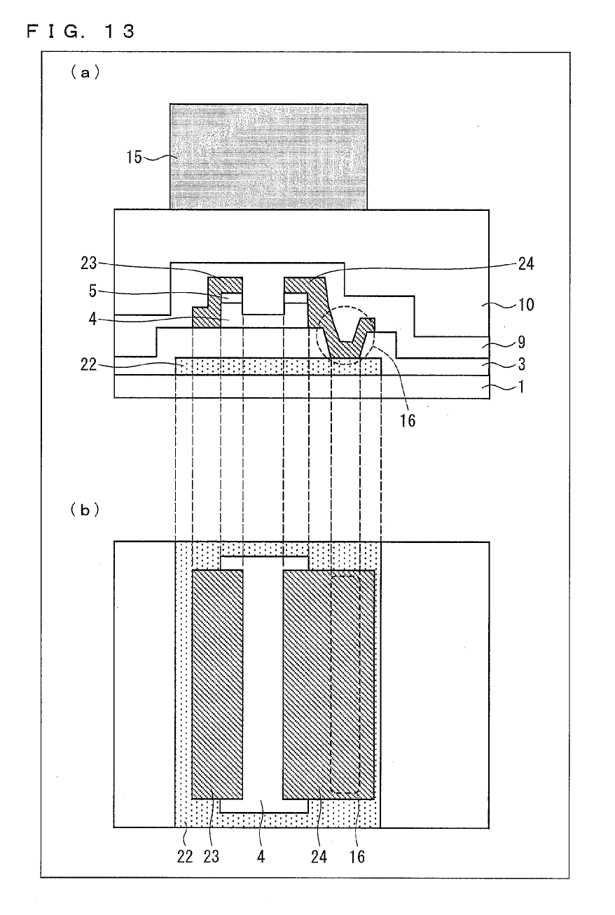

FIG. 9 is a view showing the process for manufacturing the counter substrate 100 of the display panel 101.

As shown in (a) of FIG. 9, the insulating substrate 1 is baked at substantially 200° C., and then a resin film having both UV curing property and thermosetting property, and light shielding property which resin film is heated up around 100° C. is laminated on the insulating substrate 1 so that a resin (having a thickness of substantially 1600 nm) of the resin film is transferred to the insulating substrate 1.

Subsequently, the resin (upper surface of the resin) is irradiated, by use of a photomask, with substantially 70 mJ/cm² (examination wavelength: 365 nm) of UV light containing light having a wavelength of 365 nm, so that the resin is developed.

Thereafter, the resin is baked at 220° C. for substantially 1 hour so that the light shielding film 13 is formed.

Subsequently, the above-described process conducted on the resin film having a light shielding property is conducted on a resin film made from color materials of R, G and B, so that the color filter 21 of respective colors (R, G and B) is formed so as to become a desired pattern (not shown).

Thereafter, a transparent electrically-conductive film made from ITO which film has a thickness of substantially 100 nm is formed by sputtering technique, mask evaporation method or like method, so that the common electrode 12 is formed.

Subsequently, as shown in (b) of FIG. 9, a photosensitive resin film (film thickness: substantially 3500 nm, refraction index: substantially 1.5) transmissive to ultraviolet light, visible light and infrared light which film is heated up around 100° C. as with the above-described process is laminated on the insulating substrate 1 on which the light shielding film 13 and the color filter 21 are formed, so that the photosensitive resin film is transferred to the insulating substrate 1.

Thereafter, the resin (upper surface of the resin) is irradiated, by use of a photomask, with substantially 70 mJ/cm² (examination wavelength: 365 nm) of ultraviolet ray (UV light) containing light having a wavelength of 365 nm, so that the resin is developed.

Lastly, the resin is baked at 220° C. for substantially 1 hour, so that the light transmitting member 15 is formed. The above-described resin material is a material obtained by removing the color material from the resin film used for making the color filter 21.

In this manner, the display panel 101 shown in (c) of FIG. 9 is manufactured by combining the above-described TFT array substrate 200 and counter substrate 100.

According to the above-arranged display panel 101, no liquid crystal material is provided on the light transmitting member 15. This makes it possible to keep intensity of light that enters the photodiode 17 constant regardless of the alignment state of liquid crystal. Further, the light transmitting member 15 serves as the spacer for determining a cell gap. This makes it possible to manufacture the display panel 101 without increasing in cost.

In order to manufacture the light transmitting member 15, a material may be selected in consideration of wavelength-light absorbing property (sensitivity) of the photodiode 17 and a display quality (external light reflection due to the above-described material). This expands the scope of materials to be selected.

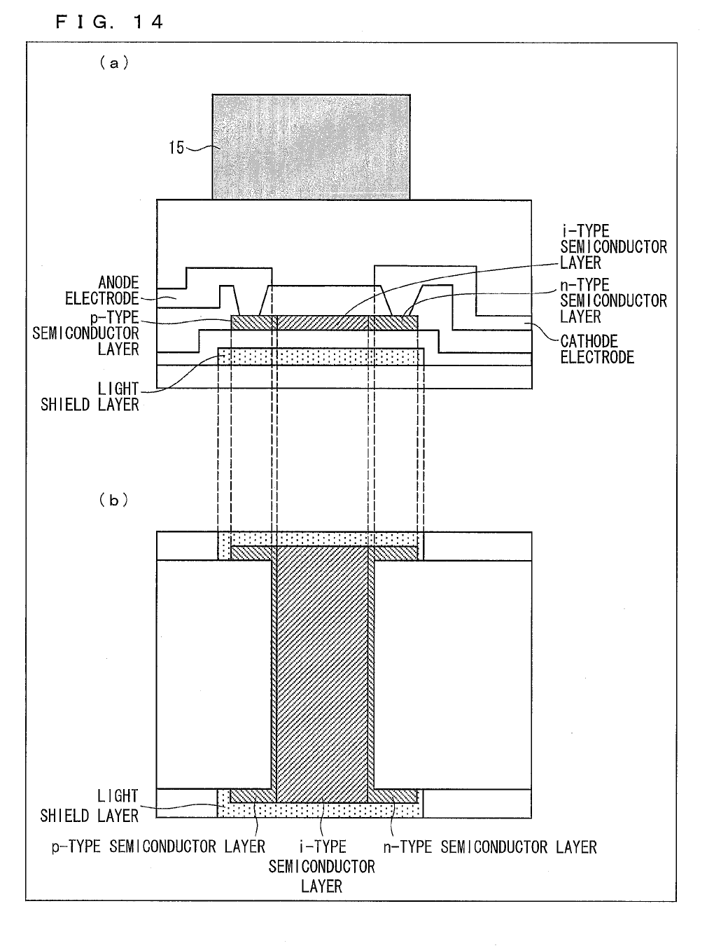

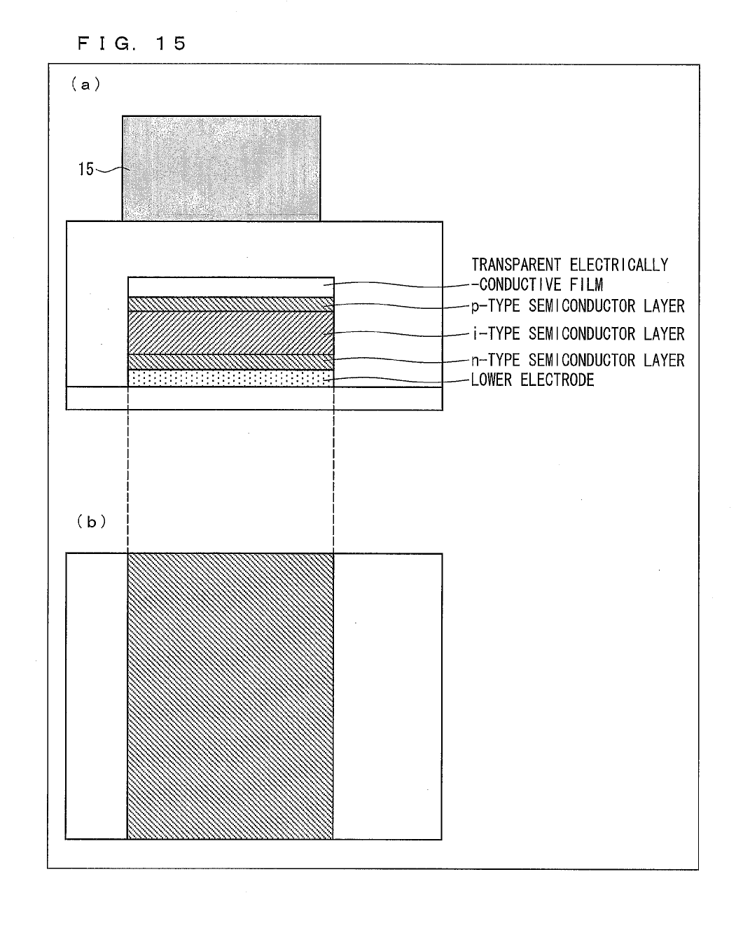

For example, the light transmitting member 15 is not necessarily transparent, and may alternatively be colored. Specifically, the light transmitting member 15 may be made from a material in which a photosensitive resin material is mixed with a pigment. FIG. 10 is a view showing an example of the colored light transmitting member 15.

Further, it is possible to adjust light transmitting property by forming a color filter material between the light transmitting member 15 and the insulating substrate 1 provided closer to the counter substrate 100. This can be attained without conducting an additional special manufacturing method.

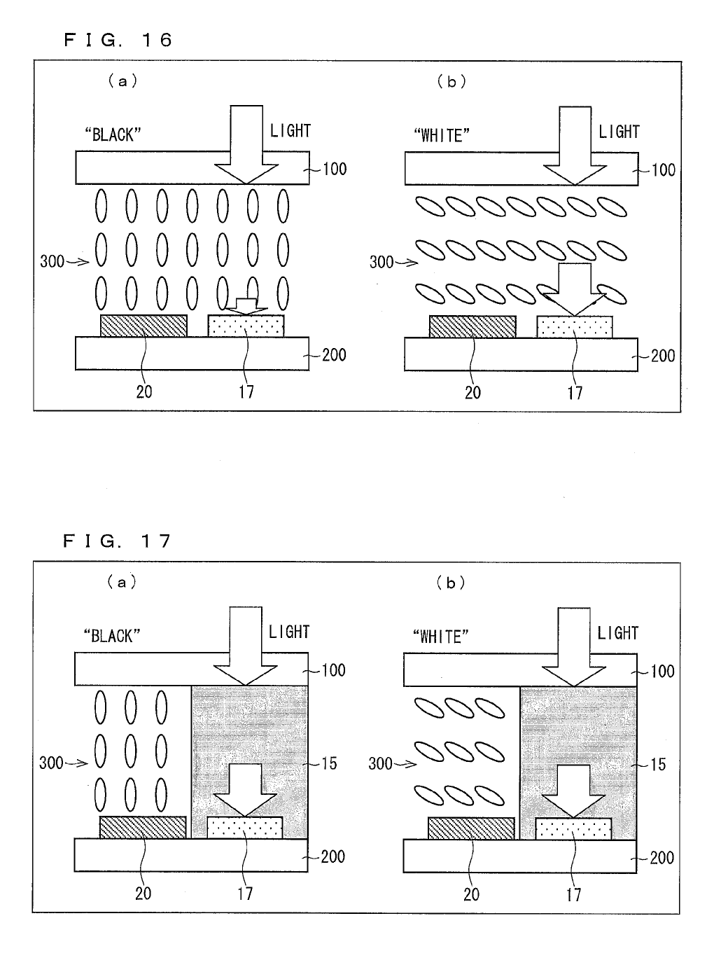

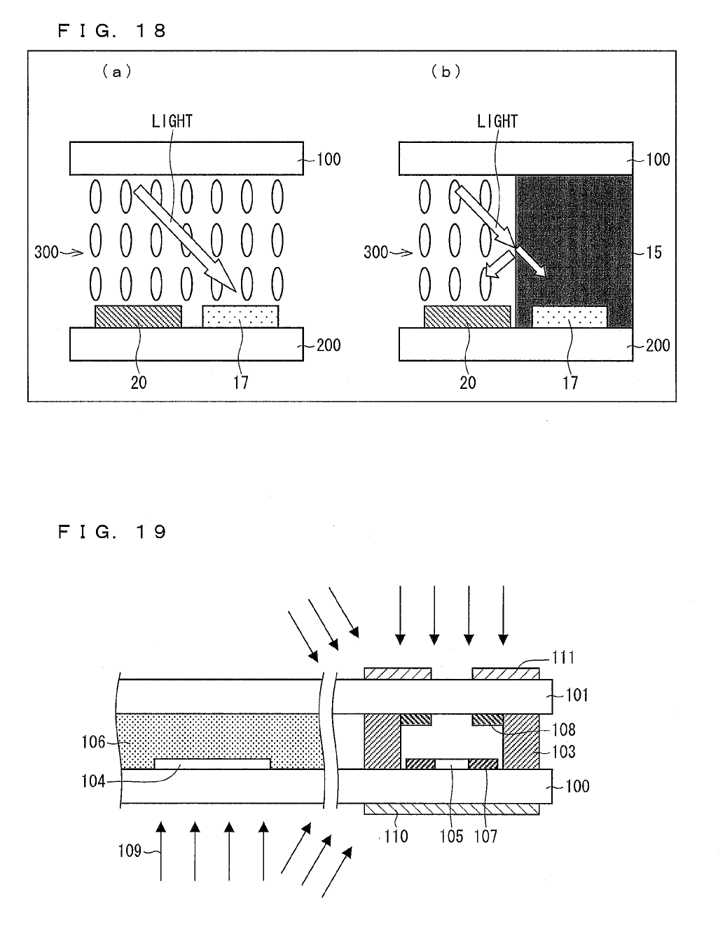

For example, the color filter 21 is provided as shown in FIGS. 11 and 12. FIG. 11 shows an example in which the color filter 21 is provided on a layer on which the light shielding film 13 is provided. FIG. 12 shows an example in which two color filters 21 shown in FIG. 11 are provided as a two-layer structure. In a case of the example shown in FIG. 11, color adjustment to the light entering the light transmitting member 15 is carried out by using just one color. However, in a case where the color adjustment is to be carried out by using a combination of two colors, the two color filters 21 may be provided so as to overlap with each other, as shown in FIG. 12. It goes without saying that providing the three color filters 21 so as to overlap one another has no problem. In a case of the example shown in FIG. 12, the two color filters 21 may be identical in colors. Alternatively, the two color filters 21 may be different in colors. The color filter 21 may be provided as appropriate.

Further, a TFT and a photodiode (photoelectric element) for driving crystal liquid are usually formed simultaneously. However, element properties required for the TFT and the photodiode are different from each other. For example, excellent performance for driving liquid crystal and a property of retaining a picture element electric potential are required for the TFT. Meanwhile, an excellent photosensitive property is required for the photodiode.

In order to manufacture the display panel 101 of the present invention, it is generally considered to take measures such as “finding a condition for forming and manufacturing a film having a device property including both properties”, “adjusting in accordance with a size of a photodiode”, “leaving a color filter on a counter substrate provided above a photodiode” and like measures. In addition to these measures, the present invention makes it possible to take a measure of “adjusting in accordance with a property of a light transmitting member provided on a photoelectric element”.

Further, the reason for coloring the light transmitting member 15 as shown in FIG. 10 is to decrease photosensitivity of the photodiode in a case where the photosensitivity is too great. Selecting an appropriate material for forming the light transmitting member 15 as described above yields the following effect. For example, in a case where (1) the display panel 101 is exposed to strong external light, it is possible to select a material that blocks infrared rays of the external light. Further, in a case where (2) stray light needs to be reduced as much as possible, it is possible to select a colored material having an excellent light absorbing property, or a material whose refraction index is greatly different from that of a liquid crystal material.

Further, it is preferable to form the light transmitting member 15 in which the material for blocking infrared rays of external light is mixed, in a case where it is considered the display panel 101 is exposed to strong external light. Examples of the material encompass a heat ray absorbent resin and polycarbonate.

It is preferable that the light transmitting member 15 is provided on the photodiode 17 so as to cover a whole region where the photodiode 17 is formed. Alternatively, the light transmitting member 15 may not be provided as such, provided that the light transmitting member 15 is provided above the photodiode 17 so as to cover a region to be affected by light and in which region electric current changes.

That is, the light transmitting member 15 may be provided so as to cover at least a semiconductor layer region constituting the photodiode 17.

Specifically, the semiconductor layer region serving as a light-receiving surface of the photodiode 17 is covered with the light transmitting member 15. This allows merely light that enters from the light transmitting member that is not affected at all by the alignment state of liquid crystal to enter the photodiode 17. It is accordingly possible to further improve detection sensitivity of the photodiode 17.

The following describes three arrangements of the photoelectric element serving as the photodiode 17.

FIGS. 13 to 15 are views each showing a position where the light transmitting member is provided, the views being different from one another in the arrangement of the photoelectric element.

In FIG. 13, (a) and (b) are views showing a region where the light transmitting member 15 is provided in a case where the photoelectric element employs a TFT structure.

As shown in (a) and (b) of FIG. 13, the light transmitting member 15 may be provided at least in a region where the gate electrode 22 overlaps with the semiconductor layer 4 and a light shielding member such as an electrode is not provided.

In (a) and (b) of FIG. 13, the gate electrode is connected to a source electrode via a contact hole. However, the gate electrode is not necessarily connected to the source electrode. As an alternative, a voltage may be applied individually to the gate electrode and the source electrode. In a case where the gate electrode is connected to the source electrode, it is possible to apply just one type of voltage (Vrst) to the gate electrode and the source electrode. This contributes to simplification of the voltage.

Further, in FIG. 14, (a) and (b) are views showing a region where the light transmitting member 15 is provided in a case where the photoelectric element is a pin photodiode employing a lateral structure.

As shown in (a) and (b) of FIG. 14, the light transmitting member 15 may be provided at least above an i-type semiconductor layer and at least in the region where the light shielding member such as an electrode is not provided.

Further, in FIG. 15, (a) and (b) are views showing a region where the light transmitting member 15 is provided in a case where the photoelectric element is a pin photodiode employing a vertical structure.

As shown in (a) and (b) of FIG. 15, the light transmitting member 15 may be provided above a region where one of p-type, i-type, and n-type semiconductor layers which one is provided closest to a side which light enters is provided.

In FIG. 16, (a) and (b) are views showing comparative examples of the present invention.

As shown in the comparative examples of (a) and (b) of FIG. 16, the liquid crystal layer 300 is formed above the photodiode 17 provided on the TFT array substrate 200.

That is, the liquid crystal material is provided above the photodiode 17. This causes intensity of light that enters from right above the photodiode 17 to change due to the alignment state of liquid crystal even in a case where external light having constant illumination intensity enters the photodiode 17.

For example, in a case of black display as shown in (a) of FIG. 16, liquid crystal provided on the photodiode 17 orients to a black display state, and therefore external light is hard to be transmitted in the liquid crystal. This causes reduction in quantity of light that the photodiode 17 receives.

Meanwhile, in a case of white display as shown in (b) of FIG. 16, the liquid crystal provided on the photodiode 17 orients to a white display state, and therefore external light is transmitted in the liquid crystal. This does not cause reduction in the quantity of light that the photodiode 17 receives. Instead, in a case where illumination intensity of external light in the case of white display is identical to illumination intensity of external light in the case of black display, this causes increase in the quantity of light that the photodiode 17 receives.

However, according to the arrangement of the present invention, the above problem can be solved.

In FIG. 17, (a) and (b) are views showing the present invention.

According to the present invention shown in (a) and (b) of FIG. 17, the light transmitting member 15 is provided on the photodiode 17 provided on the TFT array substrate 200.

Specifically, the light transmitting member 15 is provided between the TFT array substrate 200 and the counter substrate 100, and above the photodiode 17.

In this case, no liquid crystal material is provided on the photodiode 17. Therefore, external light reaches the photodiode 17 without being affected by the orientation state of liquid crystal. This causes the intensity of light that enters the photodiode 17 from right above the photodiode 17 to be constant at any time since external light having constant illumination intensity enters the photodiode 17.

Accordingly, both in a case of black display shown in (a) of FIG. 17 and in a case of white display shown in (b) of FIG. 17, no liquid crystal material is provided on the photodiode 17. This causes the intensity of light that enters the photodiode 17 to be constant at any time in the case where the external light having constant illumination intensity enters the photodiode 17. This makes it possible to stably detect light.

Further, not only the light that enters the photodiode 17 from above the photodiode 17 but also light that enters the photodiode 17 from a side where a liquid crystal display region is provided possibly enters the photodiode 17. The light that enters the photodiode 17 from the side where the liquid crystal display region is provided is detected as noise. This light is referred to as stray light.

In FIG. 18, (a) and (b) are views showing comparative examples as to how to handle stray light.

In FIG. 18, (a) shows a comparative example in which the light transmitting member 15 is not provided on the photodiode 17, and (b) shows the present invention in which the light transmitting member 15 is provided on the photodiode 17.

In a case of the comparative example shown in (a) of FIG. 18, light transmitted through the liquid crystal layer 300 provided on the display drive TFT element 20 enters the photodiode 17. Specifically, stray light due to, for example, light that diffusely reflects in a panel easily enters the photodiode 17.

Meanwhile, in a case of the present invention shown in (b) of FIG. 18, the light transmitting member 15 is provided on the photodiode 17. If refraction indexes of the liquid crystal layer 300 and the light transmitting member 15 are adjusted, it is possible to block the light transmitted through the liquid crystal layer 300 by use of the light transmitting member 15, and therefore reduce the light to enter the photodiode 17.

That is, difference in refraction index between the light transmitting member 15 and the liquid crystal layer 300 makes it possible to reflect a part of stray light. This reduces the stray light to enter the photodiode 17. In order to reflect the stray light, it is preferable to form the light transmitting member 15 with a material whose refraction index is greater than that of the liquid crystal layer 300.

For example, in a case where the refraction index of the liquid crystal material is substantially 1.4, the refraction index of the light transmitting member 15 formed with a polymer made from a material obtained by removing a color material from a color filter material ranges from substantially 1.5 to 1.6. The difference in refraction index between the liquid crystal material and the light transmitting member 15 makes it possible to reflect, on the light transmitting member 15, the stray light that enters through the liquid crystal layer 300.

Examples of the polymer encompass an alkali soluble carboxylic acid derivative polymer and a novolac resin.

Instead of employing the difference in refraction index, the light transmitting member 15 may be formed with a light absorbable material. This also reduces stray light that enters the photodiode 17.

Examples of the light absorbable material encompass the above-described color filter material and a light absorbable material such as an epoxy type visible light absorbent resin that absorbs light having a specific wavelength.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is suitably applicable to an electronics device provided with a touch panel.

### REFERENCE SIGNS LIST

1: insulating substrate
2: gate electrode
3: gate insulating film
4: semiconductor layer
5: contact layer
6: drain electrode/wiring
7: source electrode/wiring
8: storage light condensing member wiring
9: passivation film
10: interlayer insulating film
11: picture element electrode
12: common electrode
13: light shielding film
14: polarizer
15: light transmitting member
16: contact hole
17: photodiode (photoelectric element)
18: NetA voltage raising light condensing member
19: output AMP
20: display drive TFT element
21: color filter
22: gate electrode/wiring
23: drain electrode/wiring
24: source electrode/wiring
25: Vrw wiring
100: counter substrate
101: display panel
102: display scanning signal line drive circuit
103: display video signal line drive circuit
104: sensor scanning signal line drive circuit
105: sensor read circuit
106: power supply circuit
107: sensing image processing LSI
200: TFT array substrate
300: liquid crystal layer

1. A liquid crystal display device, comprising:
a TFT array substrate;
a counter substrate;
liquid crystal provided between the TFT array substrate and the counter substrate;
a photoelectric element formed on the TFT array substrate, which photoelectric element generates an electric current equivalent to intensity of irradiation light irradiated to the photoelectric element; and
a light transmitting member employing a non-hollow solid structure, which light transmitting member is provided on a light-receiving surface of the photoelectric element and sandwiched between the TFT array substrate and the counter substrate.

2. The liquid crystal display device as set forth in claim 1, wherein:
the light transmitting member is provided above the photoelectric element and in a region that is under influence of light, so that the electric current generated by the photoelectric element depends on the influence of the light in the region.

3. The liquid crystal display device as set forth in claim 1, wherein:
the light transmitting member is provided so as to cover at least a semiconductor layer region constituting the photoelectric element.

4. The liquid crystal display device as set forth in claim 3, wherein:
the photoelectric element employs a TFT structure in which the photoelectric element includes at least a gate electrode, a gate insulating film, a semiconductor layer, a source electrode, a drain electrode, and a contact layer via which the source electrode is electrically connected to the drain electrode,
the light transmitting member is provided at least in a region where the gate electrode overlaps with the semiconductor layer and neither the source electrode nor the drain electrode is provided.

5. The liquid crystal display device as set forth in claim 3, wherein:
the light transmitting element employs a lateral structure in which (i) the light transmitting element includes at least a p-type semiconductor layer, an i-type semiconductor layer, an n-type semiconductor layer, electrodes connected to the p-type semiconductor layer and the n-type semiconductor layer, respectively, and (ii) interfaces of the p-type, the i-type and the n-type semiconductor layers are perpendicular to a surface of the TFT array substrate,
the light transmitting member is provided at least above the i-type semiconductor layer and in a region where the electrodes are not provided.

6. The liquid crystal display device as set forth in claim 3, wherein:
the light transmitting element employs a vertical structure in which (a) the light transmitting element includes at least a p-type semiconductor layer, an i-type semiconductor layer, an n-type semiconductor layer, electrodes connected to the p-type semiconductor layer and the n-type semiconductor layer, respectively, and (b) interfaces of the p-type, the i-type and the n-type semiconductor layers are provided along a surface of the TFT array substrate,
the light transmitting member is provided above one of the p-type, the i-type and the n-type semiconductor layers which one is provided closest to a side which light enters.

7. The liquid crystal display device as set forth in claim 1, wherein:
the light transmitting member also serves as a spacer that determines a gap between the TFT array substrate and the counter substrate.

8. The liquid crystal display device as set forth in claim 1, comprising:
a color filter between the light transmitting member and the counter substrate.

9. The liquid crystal display device as set forth in claim 1, wherein:
the light transmitting member is made from a resin material having at least photosensitivity.

10. The liquid crystal display device as set forth in claim 1, wherein:
the light transmitting member is made from a material whose refraction index is greater than that of the liquid crystal.

11. The liquid crystal display device as set forth in claim 1, wherein:
the light transmitting member is made from a light absorbent material that absorbs light having a specific wavelength.

12. An electronics device, comprising:
a liquid crystal display device including a TFT array substrate;
a counter substrate;
liquid crystal provided between the TFT array substrate and the counter substrate;
a photoelectric element formed on the TFT array substrate, which photoelectric element generates an electric current equivalent to intensity of irradiation light irradiated to the photoelectric element; and
a light transmitting member employing a non-hollow solid structure, which light transmitting member is provided on a light-receiving surface of the photoelectric element and sandwiched between the TFT array substrate and the counter substrate.
